(19) United States
(12) Patent Application Publication
(10) Pub. No.: US 2011/0199302 A1
(43) Pub. Date: Aug. 18, 2011

(54) CAPTURING SCREEN OBJECTS USING A COLLISION VOLUME

(75) Inventors: Philip Tossell, Nuneaton (GB); Andrew Wilson, Leicestershire (GB)

(73) Assignee: Microsoft Corporation, Redmond, WA (US)

(21) Appl. No.: 12/706,580

(22) Filed: Feb. 16, 2010

(51) Int. Cl. G06F 3/033

(52) U.S. Cl. 345/158; 715/863

(57) ABSTRACT

A system is disclosed for providing a user a margin of error in capturing moving screen objects, while creating the illusion that the user is in full control of the onscreen activity. The system may create one or more “collision volumes” attached to and centered around one or more capture objects that may be used to capture a moving onscreen target object. Depending on the vector velocity of the moving target object, the distance between the capture object and target object, and/or the intensity of the collision volume, the course of the target object may be altered to be drawn to and captured by the capture object.

### BACKGROUND

In the past, computing applications such as computer games and multimedia applications used controls to allow users to manipulate game characters or other aspects of an application. Typically such controls are input using, for example, controllers, remotes, keyboards, mice, or the like. More recently, computer games and multimedia applications have begun employing cameras and software gesture recognition engines to provide a human computer interface (“HCI”). With HCI, user movements and gestures are detected, interpreted and used to control game characters or other aspects of an application.

In game play and other such applications, an onscreen player representation, or avatar, is generated that a user may control with his or her movements. A common aspect of such games or applications is that a user needs to perform movements that result in the onscreen avatar making contact with and capturing a moving virtual object. Common gaming examples include catching a moving virtual ball, or contacting a moving ball with a user's foot in soccer (football in the UK). Given the precise nature of physics, skeletal tracking and the difficulty in coordinating hand-eye actions between the different reference frames of 3D real world space and virtual 2D screen space, it is particularly hard to perform motions in 3D space during game play that result in the avatar capturing a virtual moving screen object.

### SUMMARY

The present technology in general relates to a system providing a user a margin of error in capturing moving screen objects, while creating the illusion that the user is in full control of the onscreen activity. The present system may create one or more collision volumes attached to capture objects that may be used to capture a moving onscreen target object. The capture objects may be body parts, such as a hand or a foot, but need not be. In embodiments, depending on the vector velocity of the moving target object and the distance between the capture object and target object, the course of the target object may be altered to be drawn to and captured by the capture object. As the onscreen objects may be moving quickly and the course corrections may be small, the alteration of the course of the target object may be difficult or impossible to perceive by the user. Thus, it appears that the user properly performed the movements needed to capture the target object.

In embodiments, the present technology includes a computing environment coupled to a capture device for capturing user motion. Using this system, the technology performs the steps of generating a margin of error for a user to capture a first virtual object using a second virtual object, the first virtual object moving on a display. The method includes the steps of defining a collision volume around the second object, determining if the first object passes within the collision volume, and adjusting a path of the first object to collide with the second object if it is determined that the first object passes within the collision volume.

In a further embodiment, the method includes the step of determining a speed and direction for the first object. The method also determines whether to adjust a path of the first object to collide with the second object based at least in part on a distance between the first and second objects at a given position and the speed of the first object at the given position. Further, the method includes adjusting a path of the first object to collide with the second object if it is determined at least that the speed relative to the distance between the first and second objects at the given position exceeds a threshold ratio.

In a still further embodiment, the method includes the steps of determining a speed and direction of the first object and determining whether to adjust a path of the first object to collide with the second object based on: i) a distance between the second object and a given position of the first object, ii) a speed of the first object at the given position, and iii) a reference angle defined by the path of movement of the first object and a line between the first and second objects at the given position. Further, the method includes adjusting a path of the first object to collide with the second object if it is determined that a combination of the speed and the reference angle relative to the distance between the first and second objects at the given position exceeds a threshold ratio.

### BRIEF DESCRIPTION OF THE DRAWINGS

FIG. 1 illustrates an example embodiment of a system with a user playing a game.

FIG. 2 illustrates an example embodiment of a capture device that may be used in a system of the present technology.

FIG. 3A illustrates an example embodiment of a computing environment that may be used to interpret movements in a system of the present technology.

FIG. 3B illustrates another example embodiment of a computing environment that may be used to interpret movements in a system of the present technology.

FIG. 4 illustrates a skeletal mapping of a user that has been generated from the system of FIG. 2.

FIG. 5 illustrates a user attempting to capture a moving object.

FIG. 6 illustrates a collision volume for adjusting a direction of a moving object so as to be captured by a user.

FIG. 7 illustrates a user capturing an object.

FIG. 8 is an alternative embodiment of a collision volume for adjusting a direction of a moving object so as to be captured by a user.

FIG. 9 is a flowchart for the operation of a capture engine according to a first embodiment of the present technology.

FIG. 10 is a flowchart for the operation of a capture engine according to a second embodiment of the present technology.

FIG. 11 is a flowchart for the operation of a capture engine according to a third embodiment of the present technology.

FIG. 12 illustrates a collision volume affixed to an object that is not part of a user's body.

### DETAILED DESCRIPTION

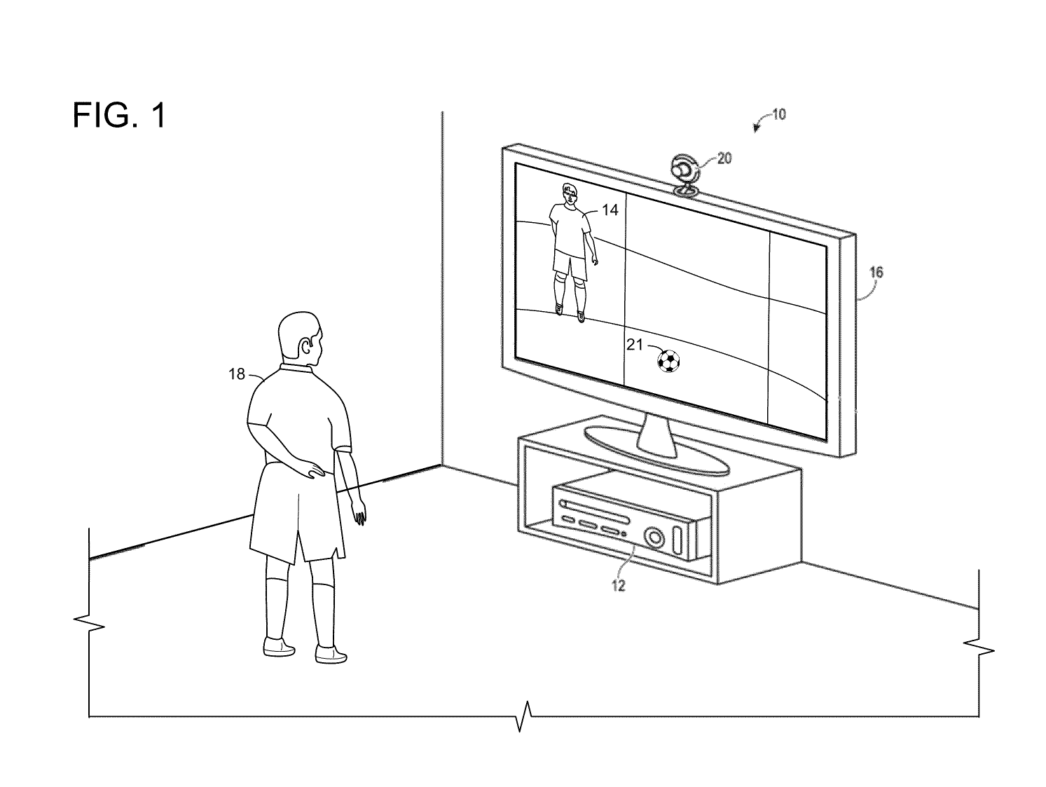

Embodiments of the present technology will now be described with reference to FIGS. 1-12, which in general relate to a system providing a user a margin of error in capturing moving screen objects, while creating the illusion that the user is in full control of the onscreen activity. In a general embodiment, the present system may create one or more “collision volumes” attached to and centered around one or more capture objects that may be used to capture a moving onscreen target object. The capture objects may be body parts, such as a hand or a foot, but need not be. Depending on the vector velocity of the moving target object and the distance between the capture object and target object, the course of the target object may be altered to be drawn to and captured by the capture object.

In further embodiments, the collision volume may be akin to a magnetic field around a capture object, having an attractive force which diminishes out from the center of the collision volume. In such embodiments, the intensity of the collision volume at a given location of a target object may also affect whether the course of an object is adjusted so as to be captured.

In any of the following described embodiments, the onscreen objects may be moving quickly and/or the course corrections may be small. Thus, any alteration of the course of the target object may be difficult or impossible to perceive by the user. As such, it appears that the user properly performed the movements needed to capture the target object.

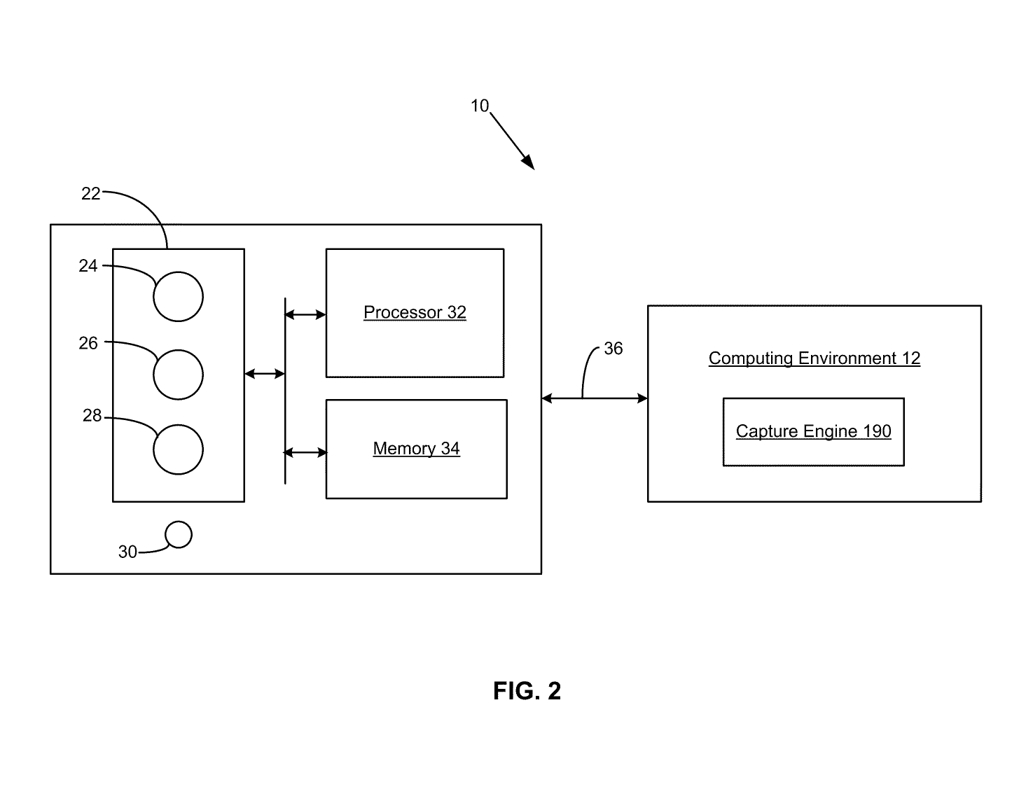

Referring initially to FIGS. 1-2, the hardware for implementing the present technology includes a system 10 which may be used to recognize, analyze, and/or track a human target such as the user 18. Embodiments of the system 10 include a computing environment 12 for executing a gaming or other application, and an audiovisual device 16 for providing audio and visual representations from the gaming or other application. The system 10 further includes a capture device 20 for detecting movement and gestures of a user captured by the device 20, which the computing environment receives and uses to control the gaming or other application. Each of these components is explained in greater detail below.

As shown in FIG. 1, in an example embodiment, the application executing on the computing environment 12 may be a football (American soccer) game that the user 18 may be playing. For example, the computing environment 12 may use the audiovisual device 16 to provide a visual representation of a moving ball 21. The computing environment 12 may also use the audiovisual device 16 to provide a visual representation of a player avatar 14 that the user 18 may control with his or her movements. The user 18 may make movements in real space, and these movements are detected and interpreted by the system 10 as explained below so that the player avatar 14 mimics the user's movements onscreen.

For example, a user 18 may see the moving virtual ball 21 onscreen, and make movements in real space to position his avatar's foot in the path of the ball to capture the ball. The term “capture” as used herein refers to an onscreen target object, e.g., the ball 21, coming into contact with an onscreen capture object, e.g., the avatar's foot. The term “capture” does not have a temporal aspect. A capture object may capture a target object so that the contact between the objects lasts no more than an instant, or the objects may remain in contact with each other upon capture until some other action occurs to separate the objects.

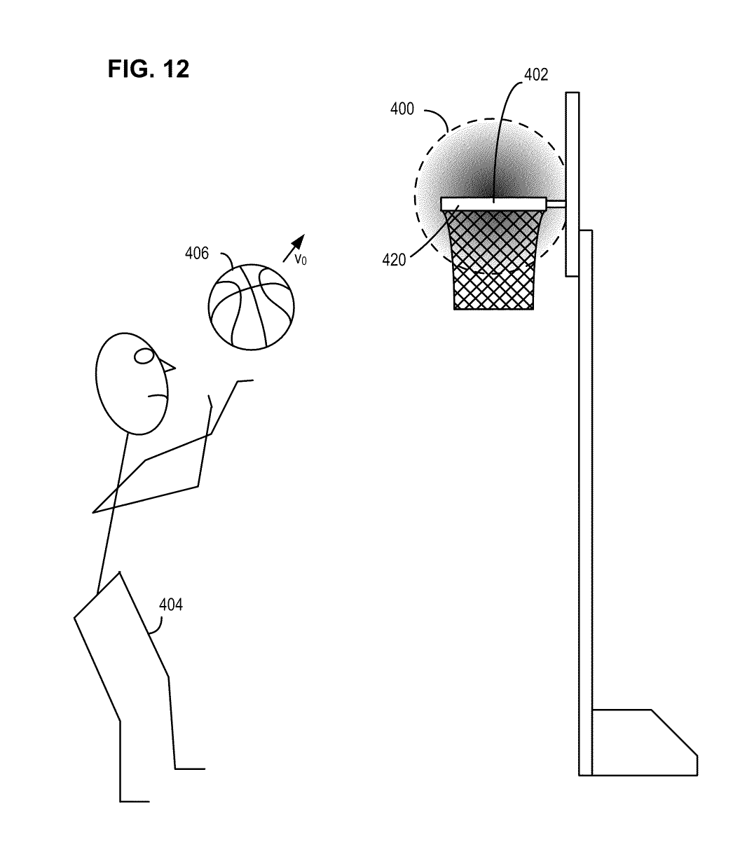

The capture object may be any of a variety of body parts, or objects that are not part of the avatar's body. For example, a user 18 may be holding an object such as a racquet which may be treated as the capture object. The motion of a player holding a racket may be tracked and utilized for controlling an on-screen racket in an electronic sports game. A wide variety of other objects may be held, worn or otherwise attached to the user's body, which objects may be treated as capture objects. In further embodiments, a capture object need not be associated with a user's body at all. As one example described below with respect to FIG. 12, a basketball hoop may be a capture object for capturing a target object (e.g., a basketball). Further details relating to capture objects and target objects are explained hereinafter.

FIG. 2 illustrates an example embodiment of the capture device 20 that may be used in the target recognition, analysis, and tracking system 10. Further details relating to a capture device for use with the present technology are set forth in copending patent application Ser. No. 12/475,308, entitled “Device For Identifying And Tracking Multiple Humans Over Time,” which application is incorporated herein by reference in its entirety. However, in an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a length in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

According to another embodiment, the capture device 20 may include two or more physically separated cameras that may view a scene from different angles, to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. A variety of known techniques exist for determining whether a target or object detected by capture device 20 corresponds to a human target. Skeletal mapping techniques may then be used to determine various spots on that user's skeleton, joints of the hands, wrists, elbows, knees, nose, ankles, shoulders, and where the pelvis meets the spine. Other techniques include transforming the image into a body model representation of the person and transforming the image into a mesh model representation of the person.

The skeletal model may then be provided to the computing environment 12 such that the computing environment may track the skeletal model and render an avatar associated with the skeletal model. The computing environment may then display the avatar 24 onscreen as mimicking the movements of the user 18 in real space. In particular, the real space data captured by the cameras 26, 28 and device 20 in the form of the skeletal model and movements associated with it may be forwarded to the computing environment, which interprets the skeletal model data and renders the avatar 24 in like positions to that of the user 18, and with similar motions to the user 18. Although not relevant to the present technology, the computing environment may further interpret certain user positions or movements as gestures. In particular, the computing environment 12 may receive user movement or position skeletal data, and compare that data against a library of stored gestures to determine whether the user movement or position corresponds with a predefined gesture. If so, the computing environment 12 performs the action stored in association with the gesture.

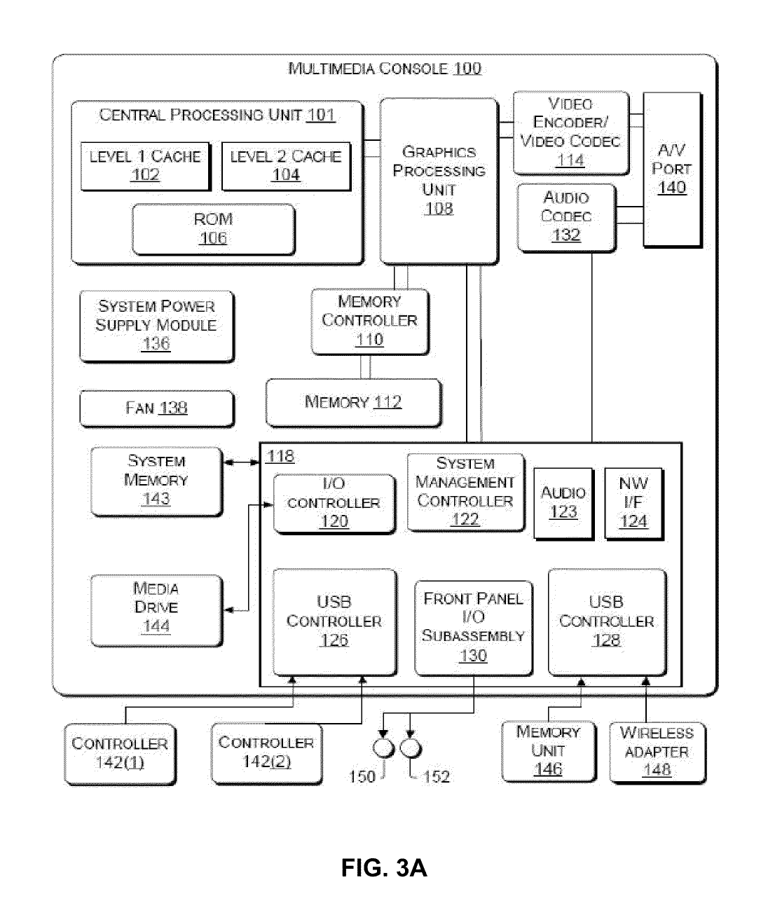

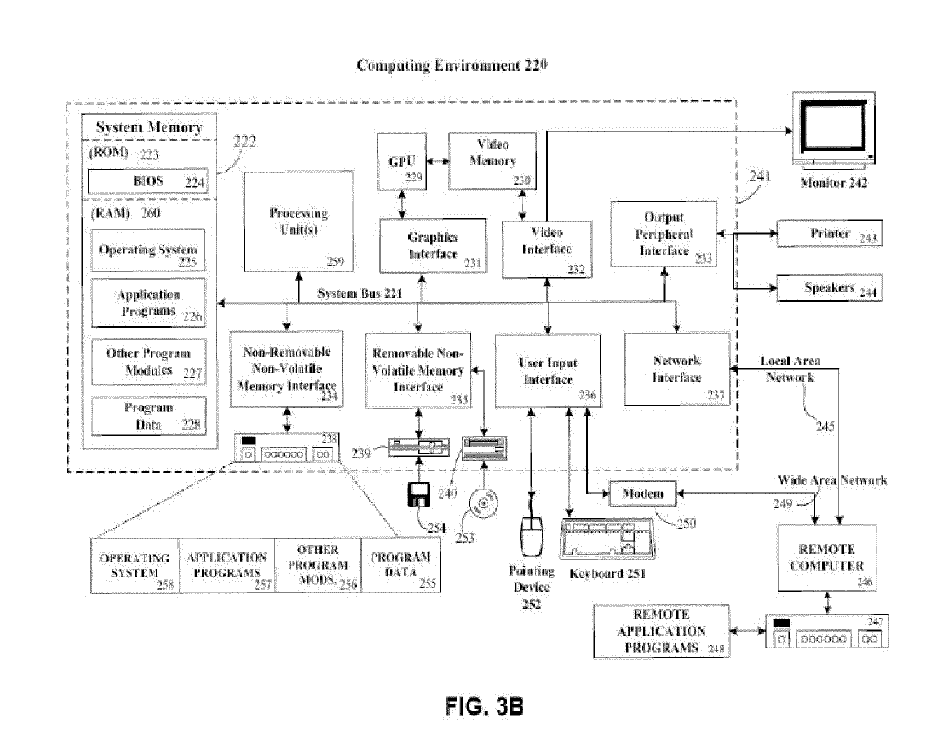

FIG. 3A illustrates an example embodiment of a computing environment that may be used to interpret positions and movements in a system 10. The computing environment such as the computing environment 12 described above with respect to FIGS. 1A-2 may be a multimedia console 100, such as a gaming console. As shown in FIG. 3A, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface controller 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

FIG. 3B illustrates another example embodiment of a computing environment 220 that may be the computing environment 12 shown in FIGS. 1A-2 used to interpret one or more positions or movements in a system 10. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 3B, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 3B illustrates operating system 225, application programs 226, other program modules 227, and program data 228.

The computer 241 may also include other removable/non-removable, volatile/nonvolatile computer storage media. By way of example only, FIG. 3B illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 3B, provide storage of computer readable instructions, data structures, program modules and other data for the computer 241. In FIG. 3B, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 3B. The logical connections depicted in FIG. 3B include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 3B illustrates remote application programs 248 as residing on memory device 247. It will be appreciated that the network connections shown are exemplary and other means of establishing a communications link between the computers may be used.

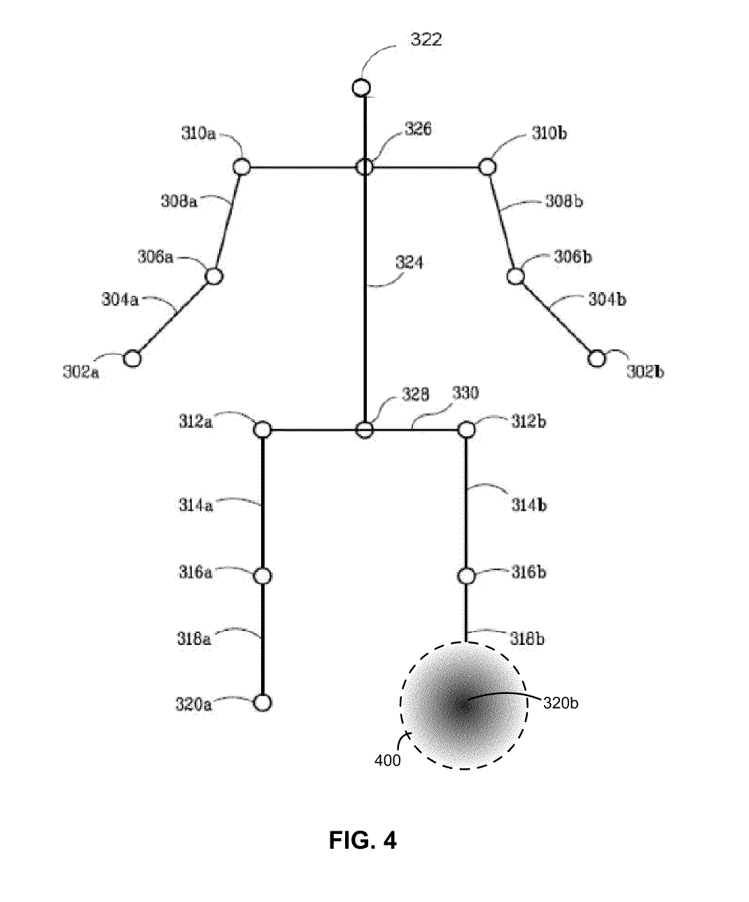

FIG. 4 depicts an example skeletal mapping of a user that may be generated from the capture device 20. In this embodiment, a variety of joints and bones are identified: each hand 302, each forearm 304, each elbow 306, each bicep 308, each shoulder 310, each hip 312, each thigh 314, each knee 316, each foreleg 318, each foot 320, the head 322, the torso 324, the top 326 and the bottom 328 of the spine, and the waist 330. Where more points are tracked, additional features may be identified, such as the bones and joints of the fingers or toes, or individual features of the face, such as the nose and eyes.

According to the present technology, one or more of the above-described body parts may be designated as a capture object having an attached collision volume 400. While the collision volume 400 is shown associated with a foot 320b, it is understood that any of the body parts shown in FIG. 4 may have collision volumes associated therewith. In embodiments, a collision volume 400 is spherical and centered around the body part with which it is associated. It is understood that it may be other shaped volumes, and need not be centered on the associated body part in further embodiments. The size of the collision volume 400 may vary in embodiments, and where there is more than one collision volume 400, each associated with different body parts, the different collision volumes 400 may be different sizes.

In general, the system 10 may be viewed as working with three frames of reference. The first frame of reference is the real world 3D space in which a user moves. The second frame of reference is the 3D machine space, in which the computing environment uses kinematic equations to define the 3D positions, velocities and accelerations of the user and virtual objects created by the gaming or other application. And the third frame of reference is the 2D screen space in which the user's avatar and other objects are rendered in the display. The computing environment CPU or graphics card processor converts the 3D machine space positions, velocities and accelerations of objects to 2D screen space positions, velocities and accelerations with which the objects are displayed on the audiovisual device 16.

In the 3D machine space, the user's avatar or other objects may change their depth of field so as to move between the foreground and background on the 2D screen space. There is a scaling factor when displaying objects in 2D screen space for changes in depth of field in the 3D machine space. This scaling factor displays objects in the background smaller than the same objects in the foreground, thus creating the impression of depth. It is understood that the size of the collision volume associated with a body part may scale in the same manner when the collision volume 400 is at different depths of field. That is, while the size of a collision volume remains constant from a 3D machine space perspective, it will get smaller in 2D screen space as the depth of field increases. The collision volume is not visible on the screen. But the maximum screen distance between a capture object and target object at which the target object is affected by the collision volume will decrease in 2D screen space by the scaling factor for capture/target objects that are deeper into the depth of field.

It is known for a user to capture a moving object when the user is able to position his or her body in a way that the computing environment interprets the user's 3D machine space body as being within the path of the moving object. When the 3D machine space position of the moving object matches the 3D machine space position of the user's body, the user has captured the object and the computing environment stops the moving object. If the computing environment senses that the moving object misses the body part (their positions do not intersect in 3D machine space), the moving object continues past the body part. In general, a collision volume 400 acts to provide a margin of error when a user is attempting to capture a target object so that a moving target object is captured even if a user has not positioned the capture object in the precise position to intersect with the path of the moving object.

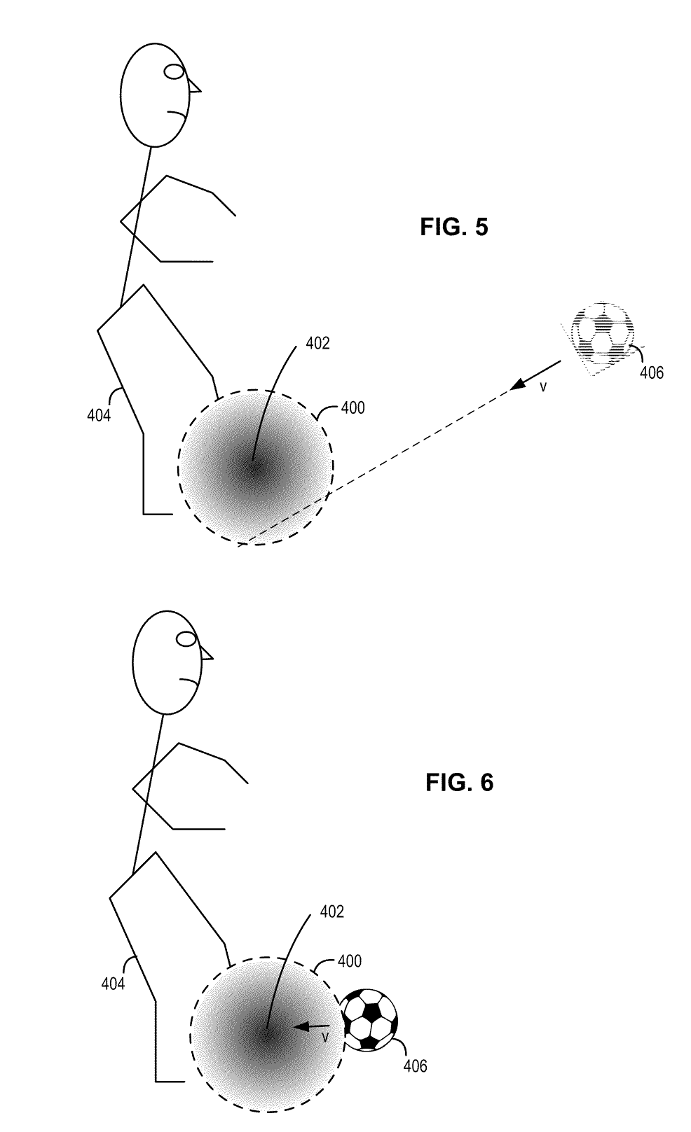

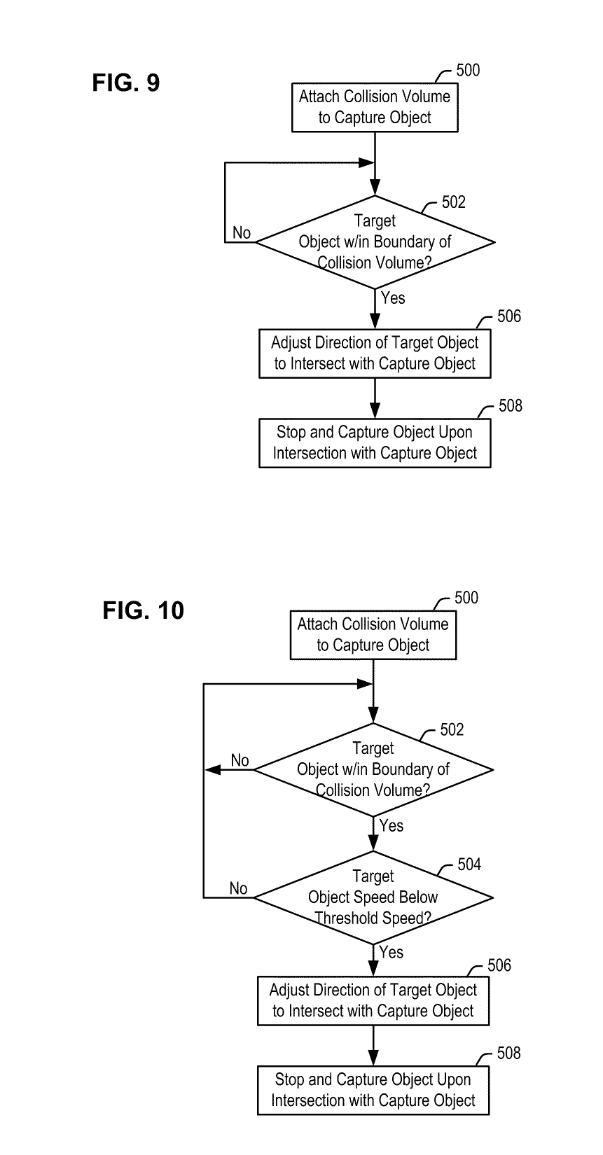

An example of the operation of a collision volume is explained below with reference to the illustrations of FIGS. 5-8 and the flowcharts of FIGS. 9-11. FIG. 5 shows a rendering of a collision volume 400 attached to a capture object 402 on a user 404 in 3D machine space. The capture object 402 in this example is the user's foot 320b. FIG. 5 further includes a target object 406, which in this example is a soccer ball. The target object 406 is moving with a vector velocity, v, representing the 3D machine space velocity of the target object 406.

A user may desire to capture a target object 406 on the capture object 402. In the example of FIG. 5, the user may wish to capture the target object soccer ball 406 on his foot 320b. Assuming the target object 406 continues to move along the same vector velocity (does not curve or change course), and assuming the user makes no further movements, the target object will miss (not be captured by) the user's foot 320b in FIG. 5.

However, in accordance with the present technology, the computing environment 12 may further include a software engine, referred to herein as a capture engine 190 (FIG. 2). The capture engine 190 examines the vector velocity of a target object 406 in relation to the capture object 402 and, if certain criteria are met, the capture engine adjusts the course of the target object 406 so that it connects with and is captured by the capture object 402. The capture engine 190 may act to correct the path of a target object according to a variety of methodologies. A number of these are explained in greater detail below.

FIG. 9 is a flowchart of a simple embodiment of the capture engine 190. In step 500, the capture engine attaches a collision volume 400 to a capture object 402. A determination as to which objects are capture objects having collision volumes attached thereto is explained hereinafter. In this embodiment of the capture engine 190, any time a target object 406 passes within the outer boundary of the collision volume 400, the path of the target object 406 is adjusted so that the target object 406 connects with and is captured by the capture object 402 to which the collision volume 400 is attached.

In step 502, the capture engine 190 determines whether a target object 406 passes within the boundary of the collision volume 400. As indicated above, the computing environment 12 maintains position and velocity information of objects moving within 3D machine space. That information includes kinematic equations describing a vector direction and a scalar magnitude of velocity (i.e., speed) of moving target objects. The computing environment 12 may also tag an object as a target object 406. In particular, where a moving object may not be captured, it would not be tagged as a target object, whereas moving objects which can be captured are tagged as target objects. As such, only those objects which can be captured are affected by the capture engine 190.

In step 506, upon the engine 190 detecting a target object 406 entering the boundary of the collision volume 400, the direction of the object 406 may be adjusted by the engine along a vector toward the capture object 402 within the collision volume 400. This simple embodiment ignores the speed of the target object, direction of the target object and intensity of the collision volume. The capture engine 190 of this embodiment looks only at whether the target object 406 enters into the collision volume 400. If so, its path is corrected so that it connects with the capture object 402 within the collision volume 400. Upon capture by the capture object 402, the target object is stopped in step 508.

The path of the target object 406 in this embodiment may be corrected abruptly to redirect it toward the capture object 402 upon entering the collision volume 400. Alternatively, the path of the target object 406 may be corrected gradually so that the object curves from its original vector to the capture object 402. The speed may or may not be adjusted once the object enters the collision volume 400 and its direction is altered. In embodiments, the size of the collision volume may be small enough that the alteration of the target object's path to connect with the capture object is not visible or not easily visible to a user.

FIG. 10 shows a further embodiment of the capture engine 190. Except for the additional step 504 described below, the capture engine of FIG. 10 is identical to that described above with respect to FIG. 9, and the above description of steps 500, 502, 506 and 508 apply to FIG. 10. In FIG. 10, after step 502 of detecting a target object 406 within the collision volume 400, this embodiment further includes the step 504 of determining whether the target object is traveling faster or slower than a threshold speed. If the object is traveling faster than that speed, its course is not corrected. However, if the target object 406 is traveling slower than the threshold speed, its course is corrected in step 506 as described above. The concept behind the embodiment of FIG. 10 is that objects traveling at higher velocities have greater momentum and are less likely to have their course altered. The threshold speed may be arbitrarily selected by the author of a gaming application.

In addition to the speed component of velocity, the embodiment of FIG. 10 may further take into consideration the angle of approach of the target object 406 with respect to the capture object 402. For example, at a given position of the target object upon entry into the collision volume, a reference angle may be defined between the path of the target object and a radius out from the center of the collision volume. Where that reference angle is 90°, the target object 406 is travelling tangentially to the capture object 402, and is less likely to be captured. On the other hand, where the reference angle approaches 180°, the target object has entered the collision volume nearly along the radius to the center, and is more likely to have its course adjusted to be captured.

Thus, the embodiment of FIG. 10 may use a threshold value which is a combination of the speed with which the capture object 402 is traveling, and a reference angle indicating the angle of incidence with which the target object 406 enters the collision volume 400. This threshold value may be arbitrarily selected to yield a practical result where if the speed is too high and/or the reference angle is near 90°, the target object is not captured.

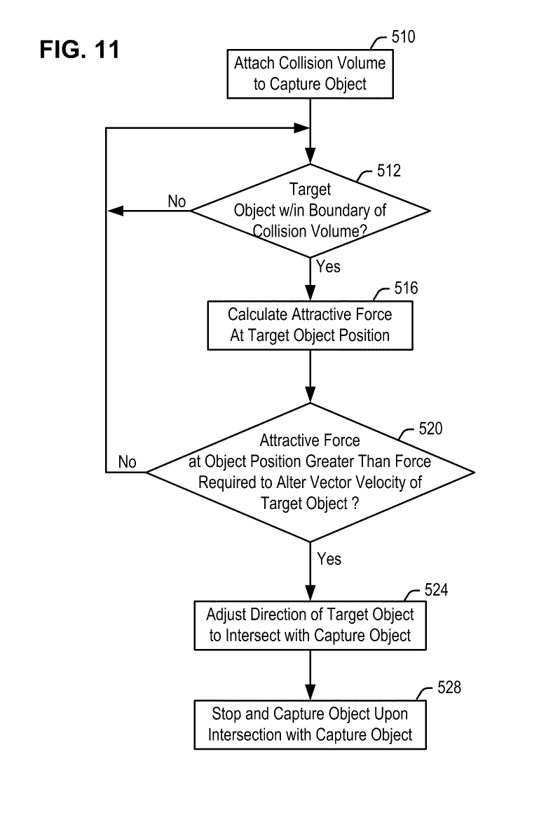

FIG. 11 is a flowchart describing a further embodiment of the capture engine where a collision volume has an attractive force which diminishes with distance away from its center. Although these forces are not visible, this collision volume is shown in FIGS. 5-7. The attractive force may decrease, linearly or exponentially away from the center. This allows the system to mathematically implement a system analogous to a magnetic field or a gravitational pull system. That is, the closer a target object 406 passes to the capture object 402, the more likely it is that the target object 406 will be pulled to the capture object 402.

In one embodiment, all distances from the center (capture object) within a collision volume may have an associated attractive force. These forces decrease further away from the center. The attractive force may be directionally independent. That is, the attractive force for all points in the collision volume 400 located a given distance from the center will be the same, regardless of the orientation of that point in space relative to the center. Alternatively, the attractive force may be directionally dependent. Thus, a target object 406 entering the collision volume 400 from a first direction and being a given distance from the center may encounter a larger attractive force as compared to another target object 406 that is the same distance from the center, but entering the collision volume 400 from a second direction. An embodiment where the attractive force is dependent may for example be used so that objects approaching the front of a user are more likely to be captured than objects approaching the user from behind him.

The embodiment of FIG. 11 may further take into consideration the vector velocity of the target object, i.e., both its speed and direction. A vector velocity is proportional to a force required to alter its course. Thus, target objects traveling at higher speeds are less likely to be affected by a given attractive force. Likewise, the direction of a moving object is used in this embodiment. Target objects 406 passing within the collision volume 400 at more tangential angles require a larger attractive force to alter their course than target objects 406 entering the collision volume 400 at more perpendicular angles.

Referring now to FIG. 11, a collision volume 400 is assigned to a capture object as explained above in step 510, and in step 512, the capture engine 190 checks whether a target object 406 has passed within the boundary of a collision volume. Steps 516 and 518 check whether the course of a target object 406 within the collision volume 400 is to be altered, and as such, step 512 may be omitted in alternative embodiments.

In step 516, the capture engine determines the attractive force exerted on the target object 406 at the calculated position of the target object. This may be done per known equations describing a change in a force as distance away from the source-generating center increases. In step 520, the capture engine determines whether to adjust the position of the target object 406 toward the capture object 402. This determination is made based on the calculated attractive force at the position of the target object 406 in comparison to the vector velocity of the target object 406. Several schemes may be used to determine whether to adjust a vector velocity of a target object toward the capture object in step 520.

In one such scheme, the capture engine may determine the force required to change the vector velocity of the target object 406 to one having a direction through the capture object 402. In order to make this calculation, the present technology assigns an arbitrary mass to the target object 406. In embodiments, a mass may be selected which is consistent with the attractive force selected for the collision volume. That is, for the selected collision volume attractive force, a mass is selected that is not so high that the direction of the target objects rarely gets corrected, and is not so low that the direction of target objects automatically gets corrected. The mass selected may be used for all target objects which are used in the present system. Alternatively, different objects may be assigned different masses. In such cases, the target objects 406 having higher masses are less likely to have their course adjusted than objects 406 having smaller masses where the vector velocities are the same.

The capture engine 190 may next compare the force to alter the course of the target object 406 to the attractive force at the target object 406. If the attractive force is greater than the force required to redirect the target object 406 in step 520, then the direction of the target object 406 is adjusted to intersect with the capture object 402 in step 524. This situation is shown in FIG. 6. On the other hand, if the attractive force is less than the force required to redirect the target object 406, then the direction of the target object 406 is not adjusted in step 520 to intersect with the capture object 402.

The capture engine 190 may repeatedly perform the above-described steps, once every preset time period. The cyclic time cycle may be for example between 30 and 60 times a second, but it may be more or less frequent than that in further embodiments. Therefore, while it may happen that the course of a target object 406 is not corrected one time through the above steps, a subsequent time through the above steps may result in the course of the target object 406 being corrected. This would happen for example where, in a subsequent time through the loop, the target object's path has taken it closer to the capture object 402 within the collision volume 400, and as such, the attractive force on the target object 406 has increased to the point where it exceeds the forces required to adjust the vector velocity of the target object 406.

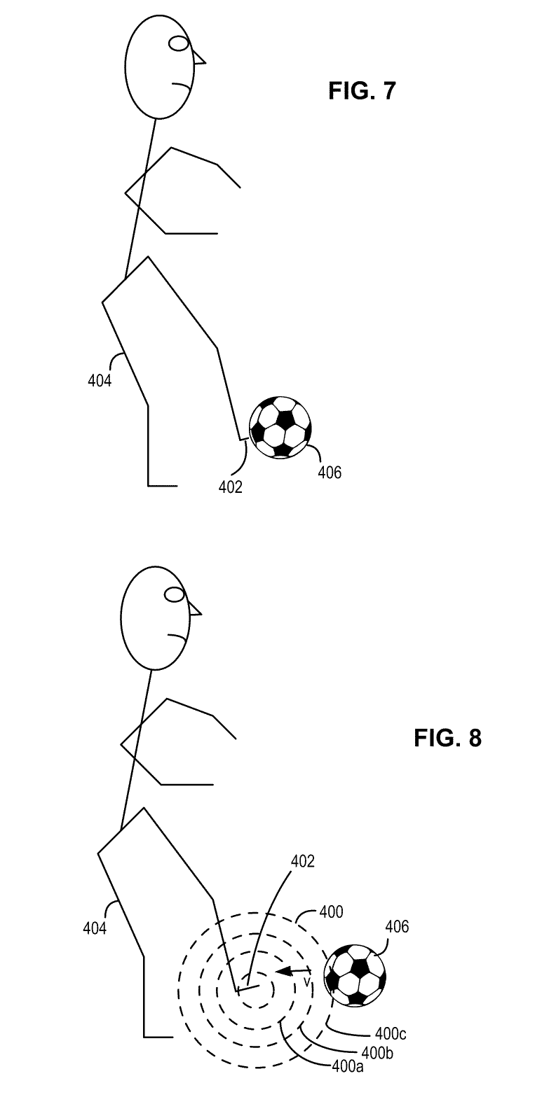

Assuming the path of a target object 406 was adjusted in step 520, upon intersection with and capture by the capture object 402, the target object 406 is stopped in step 528. This situation is shown in FIG. 7.

Given the above disclosure, those of skill in the art will appreciate other schemes which may be used to determine whether or not to adjust the path of the target object 406 for a given target object vector velocity and collision volume attractive force. As one further example, the concept of a collision volume may be omitted, and the capture engine simply examines a distance between the target object 406 and capture object 402. Such an embodiment may be used in any of the embodiments described above. For example, with respect to the embodiment of FIG. 8, instead of detecting when a target object 406 passes within a boundary of the collision volume, the capture engine may simply look at whether the target object 406 passes within an arbitrarily selected threshold distance of the capture object.

The concept of a collision volume may similarly be omitted from the embodiments of FIGS. 10 and 11. In FIGS. 10 and 11, the capture engine may look at whether the target object 406 passes within a threshold distance of the capture object, and may further look at the speed of the target object at that distance. Stated more generally, the capture engine may look at a ratio of the speed of the target object 406 relative to a space between the target object and capture object, and if that ratio exceeds a threshold ratio, the course of the object may be adjusted to pass through the capture object 402. The reference angle described above may also be combined with the speed of the capture object as described above so as to factor into the threshold ratio.

In the embodiments described above, as long as a path of a target object 406 is corrected, the target object is captured on the capture object 402. In a further embodiment, the capture engine may further look at a velocity of the capture object 402 in determining whether a target object 406 is captured on the capture object. In particular, if the capture object 402 is moving above a threshold speed, or in a direction away from or transverse to the adjusted position of the target object, the capture object 402 may not capture the target object 406. In this embodiment, the above described factors must result in the course of the target object 406 being adjusted, and the velocity of the capture object 402 must be below a threshold value, in order for the target object 406 to be captured.

In the embodiment described with respect to FIG. 11 and including a collision volume 400, the attractive forces exerted by the collision volume 400 decrease continuously (either linearly or exponentially) out from the capture object 402. In a further embodiment, the attractive forces may decrease discontinuously out from the center. That is, the attractive force decreases in discrete steps. This situation is shown in FIG. 8. The collision volume 400 in this embodiment may include a plurality of discrete volumetric force zones 400a, 400b, 400c, etc., where the attractive force in each zone is constant, but the attractive force from zone to zone changes (decreases out from the center). The collision zone 400 shown in FIG. 8 may operate according to the flowchart described above with respect to FIG. 11. The number of force zones shown in FIG. 8 is by way of example and there may be more or less force zones in further examples of this embodiment.

The above-described FIGS. 5-8 show one example where the capture object 402 is a foot, and the target object 406 is a ball. It will be appreciated that capture object 402 may be any body part so as to have an attached collision volume in further embodiments. Hands and feet are obvious examples of capture objects 402, but it is conceivable that any body part could be a capture object having an attached collision volume. Even where not normally thought of as being able to capture an object, a gaming application may for example include a user having Velcro, adhesive, etc. on a body part, thereby allowing that body part to capture objects. Moreover, the target object 406 may be any moving object capable of being captured.

In the above-described FIGS. 5-8, the capture object 402 is also shown as being attached to a body part. The capture object 402 need not be attached to a body part in further examples. For example, a user may be holding an object, such as a racquet that is also displayed on the audiovisual device 16 for hitting a moving target object. In this example, the capture object 402 is the string portion of the racquet. FIG. 12 shows a further illustration of a user 404 in 3D machine space shooting a target object ball 406 at a basketball hoop 420. In this example, the capture object 402 is the hoop 420 and it has an attached collision volume 400. The example of FIG. 12 also illustrates that other forces may act on the target object 406 in addition to the attractive force of the collision volume 400 and the vector velocity of the target object 406. For example, in FIG. 12, the force of gravity may also be simulated by the capture engine 190 (or other aspect of system 10) to alter the initial velocity vector, v₀, of the ball over time. These additional forces, such as gravity, may further be included as part of and factor into the above-described analysis of the attractive force versus the vector velocity of the target object.

Thus, as described above, the capture engine 190 according to the present technology builds some margin of error into user movement for capturing an object in a gaming application. While the present technology has been described above with respect to a gaming application, it is understood that the present technology may be used in software applications other than gaming applications where a user coordinates his or her movement in 3D real space for the purpose of capturing a moving object appearing in 2D screen space on his or her display.

In embodiments, the capture engine is further able to determine which objects are to be designated as capture objects 402 to which a collision volume 400 is attached. In some applications, the capture objects may be expressly defined in the gaming application. For example, in the basketball embodiment of FIG. 12, the hoop 420 may automatically be assigned a collision volume. In further embodiments, all body parts or other objects which can possibly capture a target object may be assigned collision volumes.

In a further embodiment, the assignment of collision volumes may not be predefined, but rather may be dynamically created and removed. In one such embodiment, the capture engine may dynamically attach collision volumes to objects, depending on potential object interaction presented to the user. For example, in FIGS. 5-8, where a target object soccer ball 406 is heading toward a user 404, the capture engine may determine all objects which could potentially capture the target object 406, and then assign collision volumes 400 to those objects. In the examples of FIGS. 5-8, the capture engine may assign collision volumes to both of the user's feet. Given the relative position of the user and the path of the target object soccer ball 406, the capture engine may further determine that it is possible for the user to capture the target object soccer ball behind the user's head. If so, the capture engine may further attach a collision volume to the user's head and/or neck. As part of this assignment, the capture engine may receive data from the gaming application as to which objects can potentially be used to capture an approaching object.

In a further embodiment, the capture engine may sense user movement and interpolate which body part the user is attempting to move to capture an approaching object. In such an embodiment, the capture engine may assign a collision volume to that object alone.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. In a system comprising a computing environment coupled to a capture device for capturing user motion, a method of generating a margin of error for a user to capture a first virtual object using a second virtual object, the first virtual object moving on a display, the method comprising:
(a) defining a collision volume around the second object;
(b) determining if the first object passes within the collision volume; and
(c) adjusting a path of the first object to collide with the second object if it is determined in said step (b) that the first object passes within the collision volume.

2. The method of claim 1, said step (a) of defining a collision volume comprising the step of defining the collision volume as a sphere around the second object, with the second object at a center of the sphere.

3. The method of claim 1, said step (a) of defining a collision volume around the second object comprising the step of defining a collision volume around one or more body parts of a representation of the user used by the computing environment.

4. The method of claim 1, said step (a) of defining a collision volume around the second object comprising the step of defining a collision volume around one or more objects spaced from the user on the display.

5. In a system comprising a computing environment coupled to a capture device for capturing user motion, a method of generating a margin of error for a user to capture a first virtual object using a second virtual object, the first virtual object moving on a display, the method comprising:
(a) determining a speed and direction for the first object;
(b) determining whether to adjust a path of the first object to collide with the second object based at least in part on a distance between the first and second objects at a given position and the speed of the first object at the given position;
(c) adjusting a path of the first object to collide with the second object if it is determined in said step (c) at least that the speed relative to the distance between the first and second objects at the given position exceeds a threshold ratio.

6. The method recited in claim 5, further comprising the step of defining a collision volume around the second object.

7. The method recited in claim 6, wherein said collision volume is defined around the second object because the second object is potentially able to capture the first object.

8. The method recited in claim 6, wherein said collision volume is defined around the second object because it is detected that the second object is attempting to capture the first object.

9. The method recited in claim 5, said step (a) of defining a collision volume around the second object comprising the step of defining a collision volume around a body part of the user.

10. The method recited in claim 5, said step (a) of defining a collision volume around the second object comprising the step of defining a collision volume around an object held by the user.

11. The method recited in claim 5, said step (a) of defining a collision volume around the second object comprising the step of defining a collision volume around an object spaced from the user's body.

12. The method recited in claim 5, wherein a chance that said step (c) determines to adjust a path of the first object to collide with the second object decreases with an increase in a speed with which the first object is travelling.

13. The method recited in claim 5, wherein a chance that said step (c) determines to adjust a path of the first object to collide with the second object increases with an increase in an angle at which the second object enters the collision volume.

14. A processor readable storage medium for a computing environment coupled to a capture device for capturing user motion, the storage medium programming a processor to perform a method of generating a margin of error for a user to capture a first virtual object using a second virtual object, the first virtual object moving on a display, the method comprising:
(a) determining a speed and direction of the first object;
(b) determining whether to adjust a path of the first object to collide with the second object based on:
i) a distance between the second object and a given position of the first object,
ii) a speed of the first object at the given position, and
iii) a reference angle defined by the path of movement of the first object and a line between the first and second objects at the given position; and
(c) adjusting a path of the first object to collide with the second object if it is determined in said step (b) that a combination of the speed and the reference angle relative to the distance between the first and second objects at the given position exceeds a threshold ratio.

15. The processor readable storage medium recited in claim 14, further comprising the step of defining a collision volume around the second object.

16. The processor readable storage medium recited in claim 15, the collision volume exerting an attractive force on the first object defined by the distance between the second object and a given position of the first object.

17. The processor readable storage medium recited in claim 16, said step of the collision volume exerting an attractive force comprising the step of exerting an attractive force which decreases linearly or exponentially with an increase in radius.

18. The processor readable storage medium recited in claim 16, said step of the collision volume exerting an attractive force comprising the step of exerting an attractive force which decreases in discrete steps with an increase in radius.

19. The processor readable storage medium recited in claim 14, wherein a speed of the first object may change over time due to simulated forces exerted on the first object, said step (a) of determining a speed and direction comprises the step of determining an average speed over time.

20. The processor readable storage medium recited in claim 14, further comprising the step of stopping the second object at the first object if the speed with which the first object is moving is below a threshold level.
